(19) United States
(12) Patent Application Publication
(10) Pub. No.: US 2022/0156211 A1
(43) Pub. Date: May 19, 2022

(54) DYNAMIC PROVISIONING OF PCIE DEVICES AT RUN TIME FOR BARE METAL SERVERS

(71) Applicant: Intel Corporation, Santa Clara, CA (US)

(72) Inventors: Eng Hun Ooi, Georgetown (MY); Su Wei Lim, Bayan Lepas (MY); Vaibhav Khamkar, San Jose, CA (US)

(21) Appl. No.: 17/559,427

(22) Filed: Dec. 22, 2021

(51) Int. Cl. G06F 13/40; G06F 13/42; G06F 15/78; G06F 9/455

(52) U.S. Cl. CPC G06F 13/4022; G06F 13/4221; G06F 9/45541; G06F 15/7807; G06F 13/409

(57) ABSTRACT

Systems or methods of the present disclosure may provide a peripheral component interconnect express (PCIe) device that comprises a programmable fabric. The programmable fabric comprises multiple PCIe physical functions. The programmable fabric also includes switch circuitry having one or more embedded endpoints that dynamically hides or exposes one or more of the multiple PCIe physical functions from a bare metal mode host server without using a reset.

### BACKGROUND

The present disclosure relates generally to bare metal servers. More particularly, the present disclosure relates to dynamically provisioning and removing PCIe devices and device types.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

A bare metal server is a physical computer server that is used by one consumer or tenant only. Rather than a virtual server running in multiple pieces of shared hardware for multiple tenants, each server may be offered up for rental as a distinct physical piece of hardware that is a functional server on its own. Although virtual servers are ubiquitous, a load peak of a single tenant may consume enough machine resources to temporarily impact other tenants. As tenants are otherwise isolated, it is difficult to manage/load balance these peak loads to avoid this “noisy neighbor effect.” Additionally, hypervisors used to isolate tenants may provide weaker isolation and be more vulnerable to security risks when compared to using different machines. Bare metal servers largely avoid these issues. Furthermore, as server costs drop as a proportion of total cost of ownership, bare metal servers are becoming more popular again. However, bare metal servers have limitations that are not applicable to virtual servers. For instance, bare metal servers may be limited to in-box software, such as the base operating system with no pre-loading of virtualization software. Accordingly, the mechanisms used to add and remove storage from virtual servers does not work for bare metal servers.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device, in accordance with an embodiment of the present disclosure;

FIG. 2 is a block diagram of the integrated circuit device of FIG. 1, in accordance with an embodiment of the present disclosure;

FIG. 3 is a diagram of programmable fabric of the integrated circuit device of FIG. 1, in accordance with an embodiment of the present disclosure;

FIG. 4 is a block diagram of a system including the programmable fabric of FIG. 3 in an add-in card with multiple devices hidden from a bare metal mode host server coupled to the add-in card, in accordance with an embodiment of the present disclosure;

FIG. 5 is a block diagram of the system of FIG. 4 with the multiple devices exposed to a bare metal mode host server coupled to the add-in card, in accordance with an embodiment of the present disclosure;

FIG. 6 is a block diagram of a topology of registers in the programmable fabric of FIG. 4, in accordance with an embodiment of the present disclosure;

FIG. 7 is a block diagram of device provisioning using configuration registers in the programmable fabric of FIG. 4, in accordance with an embodiment of the present disclosure;

FIG. 8 is a block diagram of a process for exposing or hiding devices in the programmable fabric of FIG. 4, in accordance with an embodiment of the present disclosure;

FIG. 9 is a packet diagram of a data packet used for a vendor-defined message to expose or hide devices in the programmable fabric of FIG. 4, in accordance with an embodiment of the present disclosure; and

FIG. 10 is a block diagram of a data processing system that includes the integrated circuit of FIG. 1, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present systems and techniques relate to embodiments for enabling dynamic provisioning and removal of peripheral component interconnect express (PCIe) devices and/or device types in a bare metal server platform. System re-configurability for on-demand elastic number of storage and networking devices/functions (PF) scaling and of selective function type during runtime is imperative for system architecture. This ensures ever-increasing adaptive use cases in computing, cloud, and field-programmable gate array (FPGA) industries. With the rapid adoption of bare metal platforms where only in-box software is available, the existing method used in virtualized platform to add or remove storage and networking devices does not work.

Instead, a PCIe device Physical Function (PF) provisioning method may be used for bare metal platforms when virtualization software is disallowed in a system. The provisioning method enables runtime elastic scaling of a number of PCIe Physical Functions (PF) being exposed/hidden as well as each PF's device type (storage/network/accelerator/others). The PF provisioning takes effect immediately from system user perspective. The PF provisioning method also does not use proprietary host software, system or PCIe resets in the process as avoiding these are system usage requirements for bare metal platforms in addition to virtualization software being disallowed. Such capability to support dynamic addition or removal of storage and block devices is critical for some customers where adoption of bare metal platforms is increasing. Although the foregoing discusses storage and network devices, the PF provisioning may be generalized to support broad FPGA or other programmable logic device use cases, such as communications or other areas where dynamic reconfiguration may frequently be utilized.

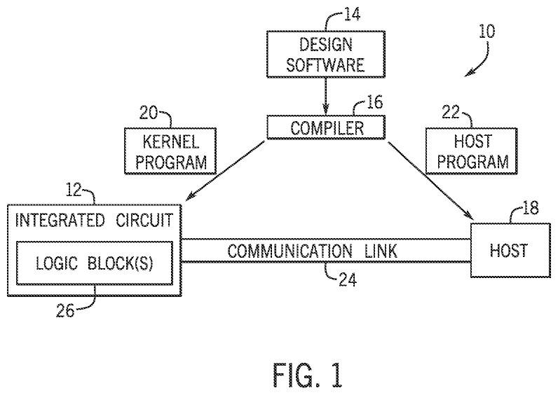

With the foregoing in mind, FIG. 1 illustrates a block diagram of a system 10 that may implement arithmetic operations. A designer may desire to implement functionality, such as the operations of this disclosure, on an integrated circuit device 12 (e.g., a programmable logic device, such as a field programmable gate array (FPGA) or an application specific integrated circuit (ASIC)). In some cases, the designer may specify a high-level program to be implemented, such as an OPENCL® program, which may enable the designer to more efficiently and easily provide programming instructions to configure a set of programmable logic cells for the integrated circuit device 12 without specific knowledge of low-level hardware description languages (e.g., Verilog or VHDL). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

The designer may implement high-level designs using design software 14, such as a version of INTEL® QUARTUS® by INTEL CORPORATION. The design software 14 may use a compiler 16 to convert the high-level program into a lower-level description. In some embodiments, the compiler 16 and the design software 14 may be packaged into a single software application. The compiler 16 may provide machine-readable instructions representative of the high-level program to a host 18 and the integrated circuit device 12. The host 18 may receive a host program 22 which may be implemented by the kernel programs 20. To implement the host program 22, the host 18 may communicate instructions from the host program 22 to the integrated circuit device 12 via a communications link 24, which may be, for example, direct memory access (DMA) communications or peripheral component interconnect express (PCIe) communications. In some embodiments, the kernel programs 20 and the host 18 may enable configuration of a logic block 26 on the integrated circuit device 12. The logic block 26 may include circuitry and/or other logic elements and may be configured to implement arithmetic operations, such as addition and multiplication.

The designer may use the design software 14 to generate and/or to specify a low-level program, such as the low-level hardware description languages described above. Further, in some embodiments, the system 10 may be implemented without a separate host program 22. Moreover, in some embodiments, the techniques described herein may be implemented in circuitry as a non-programmable circuit design. Thus, embodiments described herein are intended to be illustrative and not limiting.

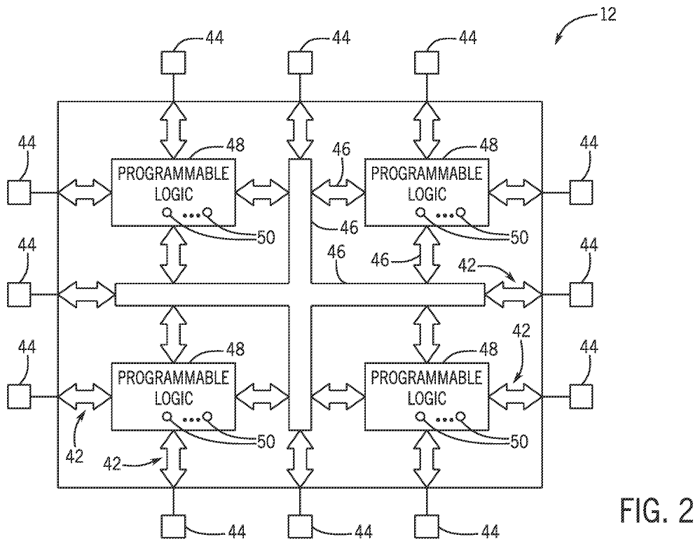

Turning now to a more detailed discussion of the integrated circuit device 12, FIG. 2 is a block diagram of an example of the integrated circuit device 12 as a programmable logic device, such as a field-programmable gate array (FPGA). Further, it should be understood that the integrated circuit device 12 may be any other suitable type of programmable logic device (e.g., an ASIC and/or application-specific standard product). The integrated circuit device 12 may have input/output circuitry 42 for driving signals off device and for receiving signals from other devices via input/output pins 44. Interconnection resources 46, such as global and local vertical and horizontal conductive lines and buses, and/or configuration resources (e.g., hardwired couplings, logical couplings not implemented by user logic), may be used to route signals on integrated circuit device 12. Additionally, interconnection resources 46 may include fixed interconnects (conductive lines) and programmable interconnects (i.e., programmable connections between respective fixed interconnects). Programmable logic 48 may include combinational and sequential logic circuitry. For example, programmable logic 48 may include look-up tables, registers, and multiplexers. In various embodiments, the programmable logic 48 may be configured to perform a custom logic function. The programmable interconnects associated with interconnection resources may be considered to be a part of programmable logic 48.

Programmable logic devices, such as the integrated circuit device 12, may include programmable elements 50 with the programmable logic 48. In some embodiments, at least some of the programmable elements 50 may be grouped into logic array blocks (LAB s). As discussed above, a designer (e.g., a customer) may (re)program (e.g., (re)configure) the programmable logic 48 to perform one or more desired functions. By way of example, some programmable logic devices may be programmed or reprogrammed by configuring programmable elements 50 using mask programming arrangements, which is performed during semiconductor manufacturing. Other programmable logic devices are configured after semiconductor fabrication operations have been completed, such as by using electrical programming or laser programming to program programmable elements 50. In general, programmable elements 50 may be based on any suitable programmable technology, such as fuses, antifuses, electrically programmable read-only-memory technology, random-access memory cells, mask-programmed elements, and so forth.

Many programmable logic devices are electrically programmed. With electrical programming arrangements, the programmable elements 50 may be formed from one or more memory cells. For example, during programming, configuration data is loaded into the memory cells using input/output pins 44 and input/output circuitry 42. In one embodiment, the memory cells may be implemented as random-access-memory (RAM) cells. The use of memory cells based on RAM technology as described herein is intended to be only one example. Further, since these RAM cells are loaded with configuration data during programming, they are sometimes referred to as configuration RAM cells (CRAM). These memory cells may each provide a corresponding static control output signal that controls the state of an associated logic component in programmable logic 48. For instance, in some embodiments, the output signals may be applied to the gates of metal-oxide-semiconductor (MOS) transistors within the programmable logic 48.

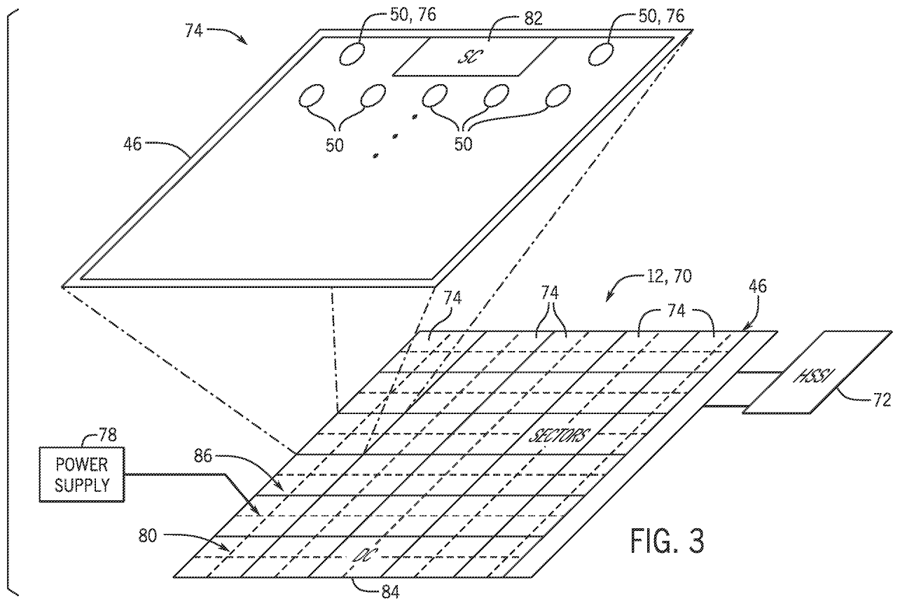

The integrated circuit device 12 may include any programmable logic device such as a field programmable gate array (FPGA) 70, as shown in FIG. 3. For the purposes of this example, the FPGA 70 is referred to as an FPGA, though it should be understood that the device may be any suitable type of programmable logic device (e.g., an application-specific integrated circuit and/r application-specific standard product). In one example, the FPGA 70 is a sectorized FPGA of the type described in U.S. Patent Publication No. 2016/0049941, “Programmable Circuit Having Multiple Sectors,” which is incorporated by reference in its entirety for all purposes. The FPGA 70 may be formed on a single plane. Additionally or alternatively, the FPGA 70 may be a three-dimensional FPGA having a base die and a fabric die of the type described in U.S. Pat. No. 10,833,679, “Multi-Purpose Interface for Configuration Data and User Fabric Data,” which is incorporated by reference in its entirety for all purposes.

In the example of FIG. 3, the FPGA 70 may include transceiver 72 that may include and/or use input/output circuitry, such as input/output circuitry 42 in FIG. 2, for driving signals off the FPGA 70 and for receiving signals from other devices. Interconnection resources 46 may be used to route signals, such as clock or data signals, through the FPGA 70. The FPGA 70 is sectorized, meaning that programmable logic resources may be distributed through a number of discrete programmable logic sectors 74. Programmable logic sectors 74 may include a number of programmable elements 50 having operations defined by configuration memory 76 (e.g., CRAM).

A power supply 78 may provide a source of voltage (e.g., supply voltage) and current to a power distribution network (PDN) 80 that distributes electrical power to the various components of the FPGA 70. Operating the circuitry of the FPGA 70 causes power to be drawn from the power distribution network 80.

There may be any suitable number of programmable logic sectors 74 on the FPGA 70. Indeed, while 29 programmable logic sectors 74 are shown here, it should be appreciated that more or fewer may appear in an actual implementation (e.g., in some cases, on the order of 50, 100, 500, 1000, 5000, 10,000, 50,000 or 100,000 sectors or more). Programmable logic sectors 74 may include a sector controller (SC) 82 that controls operation of the programmable logic sector 74. Sector controllers 82 may be in communication with a device controller (DC) 84.

Sector controllers 82 may accept commands and data from the device controller 84 and may read data from and write data into its configuration memory 76 based on control signals from the device controller 84. In addition to these operations, the sector controller 82 may be augmented with numerous additional capabilities. For example, such capabilities may include locally sequencing reads and writes to implement error detection and correction on the configuration memory 76 and sequencing test control signals to effect various test modes.

The sector controllers 82 and the device controller 84 may be implemented as state machines and/or processors. For example, operations of the sector controllers 82 or the device controller 84 may be implemented as a separate routine in a memory containing a control program. This control program memory may be fixed in a read-only memory (ROM) or stored in a writable memory, such as random-access memory (RAM). The ROM may have a size larger than would be used to store only one copy of each routine. This may allow routines to have multiple variants depending on “modes” the local controller may be placed into. When the control program memory is implemented as RAM, the RAM may be written with new routines to implement new operations and functionality into the programmable logic sectors 74. This may provide usable extensibility in an efficient and easily understood way. This may be useful because new commands could bring about large amounts of local activity within the sector at the expense of only a small amount of communication between the device controller 84 and the sector controllers 82.

Sector controllers 82 thus may communicate with the device controller 84, which may coordinate the operations of the sector controllers 82 and convey commands initiated from outside the FPGA 70. To support this communication, the interconnection resources 46 may act as a network between the device controller 84 and sector controllers 82. The interconnection resources 46 may support a wide variety of signals between the device controller 84 and sector controllers 82. In one example, these signals may be transmitted as communication packets.

The use of configuration memory 76 based on RAM technology as described herein is intended to be only one example. Moreover, configuration memory 76 may be distributed (e.g., as RAM cells) throughout the various programmable logic sectors 74 of the FPGA 70. The configuration memory 76 may provide a corresponding static control output signal that controls the state of an associated programmable element 50 or programmable component of the interconnection resources 46. The output signals of the configuration memory 76 may be applied to the gates of metal-oxide-semiconductor (MOS) transistors that control the states of the programmable elements 50 or programmable components of the interconnection resources 46.

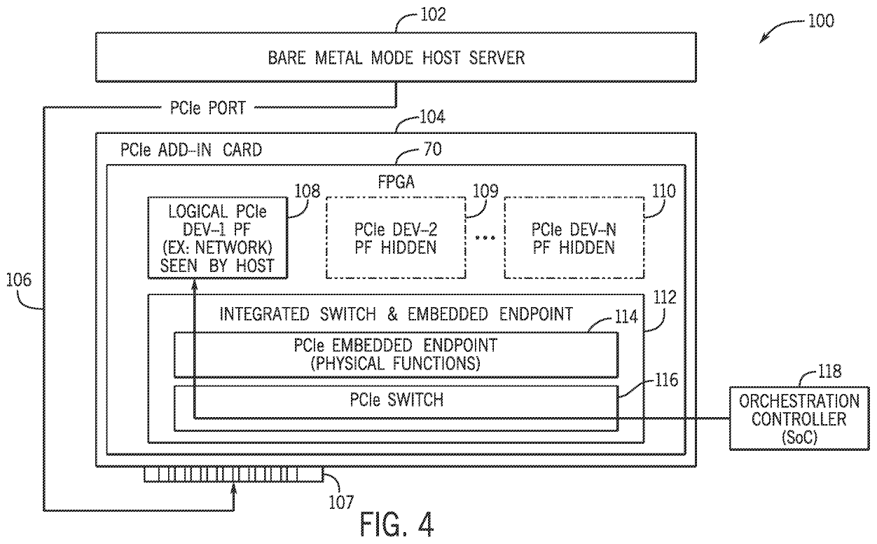

As previously noted, the FPGA 70 may be used to add flexibility of provisioning and removing devices/functions for a bare metal mode host server. For example, FIG. 4 shows a system 100 used to provision devices/functions for a bare metal mode host server 102 using a peripheral component interconnect express (PCIe) add-in card 104 that includes the FPGA 70. Although the PCIe add-in card 104 is discussed as an add-in card 104, in some embodiments, it may be implemented as any other PCIe device, such as a device that is coupled to the bare metal host server using other techniques (e.g., bonding to the motherboard of the bare metal host server during manufacture, etc.).

As previously discussed, the bare metal mode host server 102 is a bare metal platform device where a subscriber brings their own operating system. The bare metal mode platform device also allows no virtualization by the cloud service provider providing the bare metal mode host server 102. Indeed, in the bare metal mode host server 102, only a standard inbox driver if present for a physical function (PF). Furthermore, the bare metal mode host server 102 and/or its ancillary components may not use a reset of the bare metal mode host server 102 and/or the components to make changes. Furthermore, the bare metal mode host server 102 may be unable to use proprietary host software. Due to these restrictions application to bare metal platform devices, the bare metal mode host server 102 may be unable to utilize single root I/O virtualization (SR-IOV) or scalable I/O virtualization (SIOV).

The PCIe add-in card 104 may be an accelerator card, a network interface controller (NIC) card, or any other PCIe card that may be included in the bare metal mode host server 102 via a PCIe port 106 via a PCIe connector 107 having one or more “conductive fingers” for transferring data between the PCIe add-in card 104 and the bare metal mode host server 102.

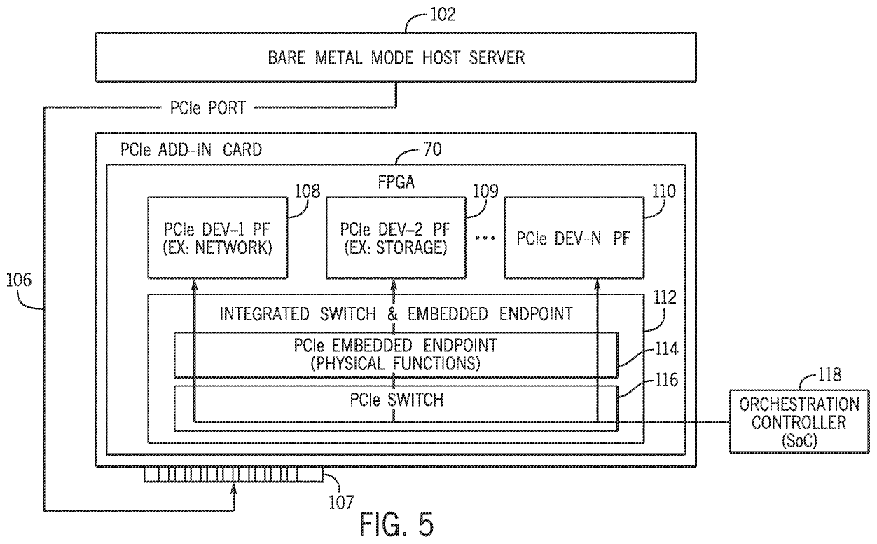

The PCIe add-in card 104 also includes a number (e.g., 0, 1, or more) of provisioned devices at run time. For instance, a device 108 may be provisioned at startup of the system 100 and may be visible by default when the system 100 is started up. In other words, the device 108 is visible to the subscriber OS/software by default. Additionally or alternatively, more devices may be visible when the system 100 is started up where the subscriber OS/software discovers more than 1 PF in the PCIe add-in card 104. There are also may be a number (e.g., 0, 1, or more) hidden devices, such as devices 109 and 110, at startup of the system 100 and/or the PCIe add-in card 104. The number of devices 108, 109, and 110 may be set in the FPGA 70 using a UI (e.g., in the design software 15). Additionally, the number of devices 108, 109, and 110 hidden or exposed by default at startup may also be set in the FPGA 70 using the UI. FIG. 5 shows the system 100 with devices 109 and 110 exposed. As discussed below, the system 100 may expose the devices 109 and 110 to present the arrangement shown in FIG. 5. Furthermore, the system 100, as illustrated in FIG. 5, may hide the devices 109 and 110 to present the arrangement shown in FIG. 4. In other words, the system 100 may dynamically hide or expose any of the devices/PFs in the PCIe add-in card 104.

The devices 108, 109, and 110 may have various device types, such as storage, communication, and/or other suitable types. This device type may be specified through provisioning of the devices 108, 109, and/or 110.

The devices/PFs, such as the devices 108, 109, and 110, in the PCIe add-in card 104 may utilize a connection to the PCIe connector 107 to utilize the PCIe port 106. To provide this connection, the PCIe add-in card 104 includes an integrated switch and embedded endpoint 112. The integrated switch and embedded endpoint 112 may include multiple PCIe embedded endpoints 114 for PFs and a PCIe switch 116. An orchestration controller system on chip (SoC) 118 may be used to control the PCIe switch 116 and/or the devices 108, 109, and 110. The PCIe switch 116 may be and/or include a virtual switch. In some embodiments, a discrete switch as discrete switches may be costly and would utilize physically added or removed discrete endpoints which is not possible a data center when PFs are to be added/removed/updated instantly. However, having a virtual integrated PCIe Switch alone would lack the ability to provision different number of PFs and different PF device type at run time. Additionally, server or graphics chipsets may have virtual switch ports (VSPs) to statically attach multiple Endpoints but lacks elastic provisioning a number of pre-existing PFs in the system as well as lacking the ability to specify each PFs device type.

The system may be used to provision the devices 109 and 110 at run time. As previously noted, the system 100 is to enable PCI PF/devices to be added and removed without going through a link down or link reset as this is not supported if the device is exposed as a multi-function endpoint device that is a typical FPGA PCIe configuration. Furthermore, as the link reset is not available reconfiguration using a partial or full configuration may not be feasible without a reset of the PCIe add-in card 104 or the system 100. To support the provisioning, the PCIe switch 116 is defined such that each of the PCIe PFs/devices can be dynamically added/removed be connected to a downstream port of the PCIe switch 116. This allows customers to emulate a hot plug on each of the function connected to the downstream port of the PCIe switch 116 without requiring a PCIe physical link between switches and integrated endpoints. This hot-plug may be supported as part of the default PCI Hot-Plug software stack for the PCIe port 106. The orchestration controller SoC 118 may be on the same board of the PCIe add-in card 104 as the FPGA 70 to perform control path management for the FPGA application to emulate a hot-plug event on the PCI functions connected to the downstream port of the PCIe switch 116. This allows the software stack of the orchestration controller SoC 118 to have control over the addition/removal of PCIe PF devices in alignment with the software stack on the orchestration controller SoC 118 side. In other words, the provisioning may be performed on top of PCIe topology Host Root Port, PCIe switch hierarchy and endpoints in order to allow runtime elastic scaling of number of PFs and/or each PF's device type (e.g., storage, network, accelerator, or other types) when virtualization software is disallowed in a system as well as other requirements previously mentioned.

At design time or coding of a runtime library (RTL), the PCIe add-in card 104 is designed to have maximum N-number of PCIe device Physical Functions (PF) allowed for system device provisioning. As discussed above, to expose or hide the correct number of devices on-demand as paid by end user during provisioning, the system 100 emulates the hot plug capability of a downstream port of the PCIe switch 116 as the underlying mechanism to hide or show each integrated PCIe device/PF beneath the ports of the PCIe switch 116. By using the PCIe hot plug feature this way, the system 100 enables an elastic device number of PF's provisioning to take advantage of existing PCIe hot plug inbox software driver support in the user's OS (e.g., Linux and Windows). This usage also meets the requirement of no system/PCIe reset and no proprietary software driver running on the host CPU in the bare metal mode host server 102. Instead, the host CPU relies on communication with the PCIe add-in card 104. In other words, each of the N-numbers of PCIe PF's may be logically placed below a PCIe Switch Downstream Port as per PCIe specification (Switch topology).

To expose hidden devices (e.g., the devices 109 and 110), the FPGA 70 may be used to expose the hidden devices 1) using the orchestration controller SoC 118 to perform backdoor register programming of registers used to expose/hide the devices 109 and 110 or 2) using vendor-defined messaging (VDM) to cause the integrated switch and embedded endpoint to expose/hide devices without the orchestration controller SoC 118.

The orchestration controller SoC 118 may be used to perform backdoor register programming as software executing on the orchestration controller SoC 118 may know where to touch registers to hide/expose the devices. The software may also be able to access/change device type for the devices via known register locations. The PCIe switch 116 may be used to implement this type of hiding/exposure by providing hooks for the orchestration controller SoC 118 to manage the control plan to emulate the virtual hot-plug event (e.g., a removal or addition of a PF device). The PCIe switch 116 also provides an embedded endpoint device header for the orchestration controller SoC 118 to configure the device type (e.g., network, storage, acceleration, etc.). Using these provisions, the orchestration controller SoC 118 is enabled to hide/expose the embedded endpoint that is part of the PCIe switch 116, to the remote bare metal mode host server 102.

Regardless of mechanism used to perform the exposure/hiding of the devices, the system 100 enables a system owner to perform dynamic PCIe updates at runtime including 1) hiding/showing variable numbers of PCIe PFs/devices, 2) updating device types in each PF, such as non-volatile memory (NVMe), virtIO-blk, virtio-net, and other types according to provisioning.

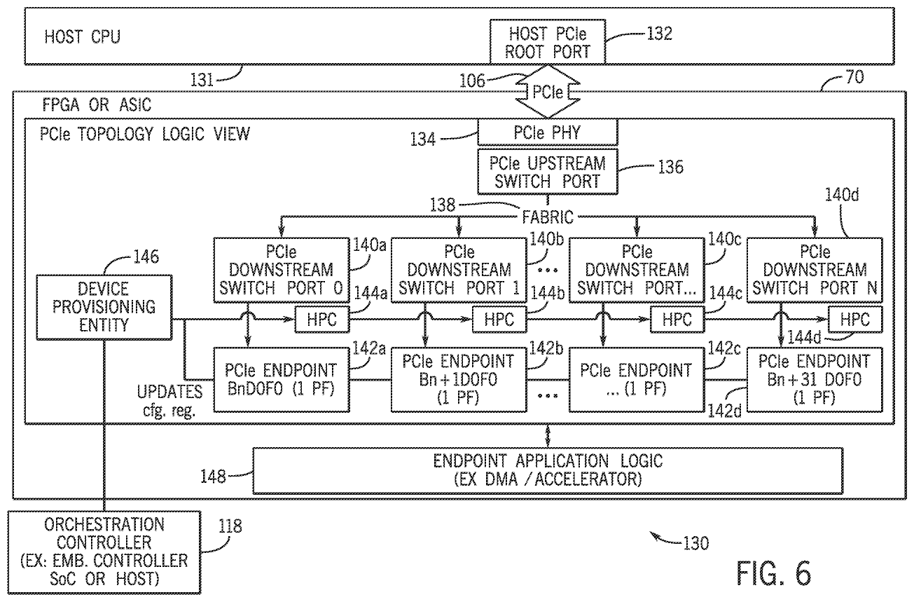

FIG. 6 is a block diagram of a system 130. The system 130 may be a subset of the system 100. The system 130 includes a host processor 131 of the bare metal mode host server 102. The host processor 131 includes a host PCIe root port 132 that is used to communicate with a PCIe physical layer connection 134 of the FPGA 70 via the PCIe port 106. Also, as noted in the system 130, the FPGA 70 may include or be replaced by an application-specific integrated circuit (ASIC). The PCIe physical layer connection 134 couples to a PCIe upstream switch port 136 that is part of the PCIe switch 116. The PCIe upstream switch port 136 may be used to route data to the devices through the PCIe port 106. Through a fabric 138 of the FPGA 70, the PCIe upstream switch port 136 couples to PCIe downstream switch ports 140a, 140b, 140c, and 140d that correspond to respective devices/PFs/endpoints 142a, 142b, 142c, and 142d. These PCIe downstream switch ports 140a, 140b, 140c, and 140d gate access to the respective devices/PFs/endpoints 142a, 142b, 142c, and 142d. When a change is made to add or remove the respective devices/PFs/endpoints 142a, 142b, 142c, and 142d, respective hot-plug controllers 144a may be utilized as previously discussed.

The access to the respective devices/PFs/endpoints 142a, 142b, 142c, and 142d from the PCIe port 106 via the PCIe upstream switch port 136 and the PCIe downstream switch ports 140a, 140b, 140c, and 140d is controlled via registers of the PCIe upstream switch port 136 and the PCIe downstream switch ports 140a, 140b, 140c, and 140d. A device provisioning entity 146 may send configuration signals to the PCIe upstream switch port 136 and the PCIe downstream switch ports 140a, 140b, 140c, and 140d to reconfigure the PCIe upstream switch port 136 and the PCIe downstream switch ports 140a, 140b, 140c, and 140d to expose/hide the respective devices/PFs/endpoints 142a, 142b, 142c, and 142d. The device provisioning entity 146 may include logic and/or circuitry implemented in the FPGA 70 to enable the orchestration controller SoC 118 to perform the reconfiguration of the respective registers. In other words, the device provisioning entity 146 may be implemented in hardware, software, or a combination of hardware and software. Additionally or alternatively, the device provisioning entity 146 may include circuitry that enables the host processor 131 to decode/translate VDMs to perform the reconfiguration of the respective registers. Thus, the hiding and exposure of the respective devices/PFs/endpoints 142a, 142b, 142c, and 142d may be performed using hardware, software, or a combination thereof. The FPGA 70 may also enable access/use of endpoint application logic for the functions, such as direct memory access (DMA) functions, accelerator functions, and the like.

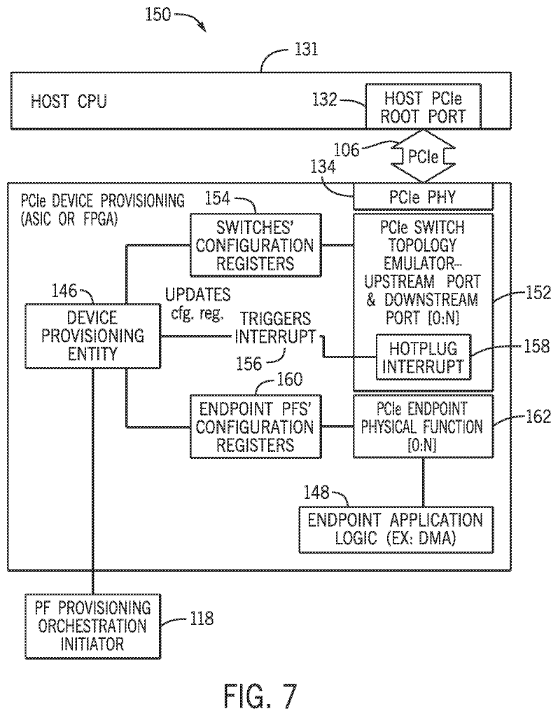

FIG. 7 is a block diagram of a system 150 that is an alternative representation of the system 130 that shows the registers of the PCIe upstream switch port 136 and the PCIe downstream switch ports 140a, 140b, 140c, and 140d to expose/hide the respective devices/PFs/endpoints 142a, 142b, 142c, and 142d. The system 150 includes a PCIe switch topology emulator 152 that is part of the PCIe switch 116. The PCIe switch topology emulator 152 also includes the PCIe upstream switch port 136 and the PCIe downstream switch ports 140a, 140b, 140c, and 140d that couple to the respective devices/PFs/endpoints 142a, 142b, 142c, and 142d of a PCIe endpoint physical function circuitry 162. The device provisioning entity 146 configures the switches' configuration registers 154 used to hide/expose the respective devices/PFs/endpoints 142a, 142b, 142c, and 142d by changing the way that the PCIe upstream switch port 136 and the PCIe downstream switch ports 140a, 140b, 140c, and 140d behave.

When a change is to be made, the device provisioning entity 146 sends one or more interrupts 156 to respective interrupt controllers 158 (e.g., the hot-plug controllers 144). The device provisioning entity 146 also access or reconfigures endpoint PF configuration registers 160 as part of the change. The change to the endpoint PF configuration registers 160 may be used to change device types while the access may be used to determine a device type of the device when exposing a particular device type.

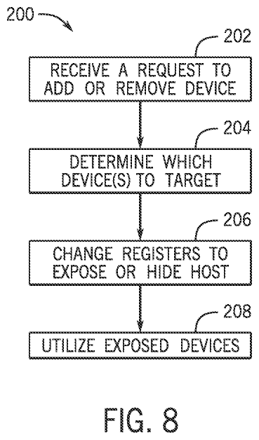

FIG. 8 is a flow diagram of a process 200 that may be used to expose/hide PFs/endpoints/devices. The FPGA 70 receives a request to add or remove devices (block 202). The request may be made from the host processor 131 based on a user inputting a request into the bare metal mode host server 102. The request may indicate how many devices to add, may indicate a specific device (e.g., via indexing or naming), indicate a device type, or a combination thereof. The orchestration controller SoC 118 and/or the device provisioning entity 146 determines which devices to target as part of a change (block 204). For instance, the orchestration controller SoC 118 and/or the device provisioning entity 146 may perform the determination for backdoor register programming embodiments while the device provisioning entity 146 performs the determination for VDMs. Additionally, the determination may be at least partially based on accessing the endpoint PFs' configuration registers 160. The determination may include identifying a PCIe slot number that corresponds to a switch downstream port 140.

The orchestration controller SoC 118 and/or the device provisioning entity 146 then changes registers to expose or a hide one or more devices from the host (block 206). The orchestration controller SoC 118 and/or the device provisioning entity 146 may update various headers as part of the change. For instance, the device's PCI header configuration register reflects the device type. In some embodiments, additional details may be included such as a sub-class code, a vendor identifier, a device identifier. The switch downstream ports 140 may have a link status configuration register that include a link status register data layer link active bit (e.g., bit 13) that may set to active to add a device and inactive to remove a device. The switch downstream ports 140 may have a slot status register that is used to trigger hot plug interrupts to the host processor 131 when adding or removing devices. For instance, a data link layer state changed bit (e.g., bit 8) in the slot status register may be changed to changed when adding or removing devices. Additionally, a presence detect state bit (e.g., bit 3) in the slot status register may be toggled from empty to present when a change is made/to be made.

After performing the change, the bare metal mode host server 102 may utilize the FPGA 70 to utilize exposed devices (block 208).

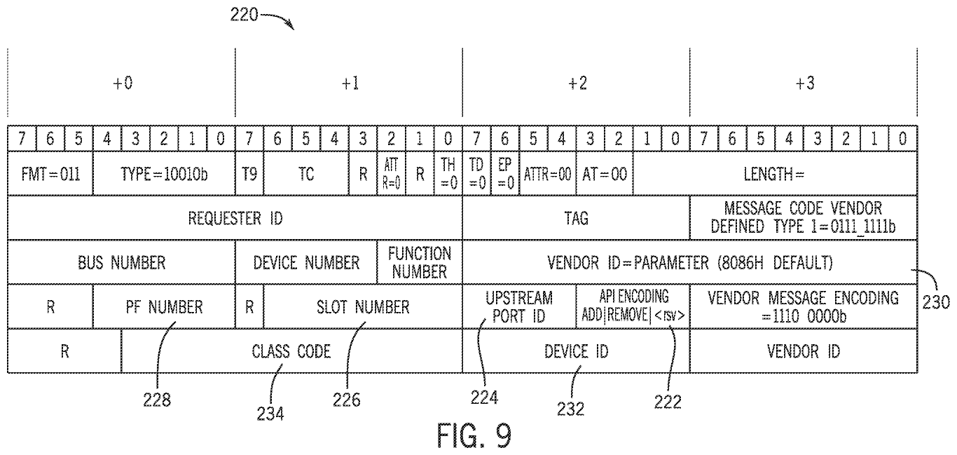

FIG. 9 is a diagram of a data packet 220 that may be used in the VDM-based communication. The data packet 220 may include standard fields and sizes as required by the PCIe specification. For instance, it may include message request TLP type, vendor_defined type 1, TC, routing by id, and vendor message encoding fields. The data packet 220 may also include one or more fields that may be used to hide/expose devices. For instance, the illustrated data packet 220 includes an application programming interface (API) encoding field 222. The illustrated embodiment of the API encoding field 222 includes four bits, but in some embodiments, it may include more or fewer bits. The API encoding field 222 may have a first pattern (e.g., 0000) that corresponds to an add device action and a second pattern (e.g., 0001) that corresponds to a remove device action. The API encoding field 222 may have additional encoded patterns that cover other actions, such as a replace device.

The data packet 220 also includes an upstream port identifier field 224 for each upstream port assigned by the product (e.g., PCIe add-in card 104) that the API will be applied onto if the product has multiple upstream ports. If there are not multiple upstream ports, this field may be ignored.

The data packet 220 may also include a PCIe switch slot number field 226 to indicate a slot to be added in an add device action or to remove device action. The data packet 220 may further include a PF number field 228 to indicate how many devices to add or remove. A vendor identifier field 230 may be used to confirm the vendor for which the VDM is to be used. Similarly, a device identifier field 232 may be used to confirm the device targeted for the vendor-based VDM. The data packet 220 may further include a class code field 234 that is used to specify a register level of the registers to be accessed/changed.

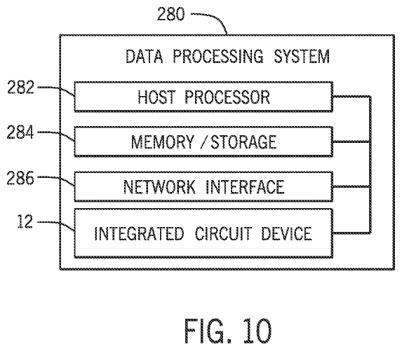

The integrated circuit device 12 may be a data processing system or a component included in a data processing system. For example, the integrated circuit device 12 may be a component of a data processing system 280 shown in FIG. 10. The data processing system 280 may include a host processor 282 (e.g., a central-processing unit (CPU)), memory and/or storage circuitry 284, and a network interface 286. The data processing system 280 may include more or fewer components (e.g., electronic display, user interface structures, application specific integrated circuits (ASICs)). The host processor 282 may include any suitable processor, such as an INTEL® Xeon® processor or a reduced-instruction processor (e.g., a reduced instruction set computer (RISC), an Advanced RISC Machine (ARM) processor) that may manage a data processing request for the data processing system 280 (e.g., to perform debugging, data analysis, encryption, decryption, machine learning, video processing, voice recognition, image recognition, data compression, database search ranking, bioinformatics, network security pattern identification, spatial navigation, or the like). The memory and/or storage circuitry 284 may include random access memory (RAM), read-only memory (ROM), one or more hard drives, flash memory, or the like. The memory and/or storage circuitry 284 may hold data to be processed by the data processing system 280. In some cases, the memory and/or storage circuitry 284 may also store configuration programs (bitstreams) for programming the integrated circuit device 12. The network interface 286 may allow the data processing system 280 to communicate with other electronic devices. The data processing system 280 may include several different packages or may be contained within a single package on a single package substrate.

In one example, the data processing system 280 may be part of a data center that processes a variety of different requests. For instance, the data processing system 280 may receive a data processing request via the network interface 286 to perform acceleration, debugging, error detection, data analysis, encryption, decryption, machine learning, video processing, voice recognition, image recognition, data compression, database search ranking, bioinformatics, network security pattern identification, spatial navigation, digital signal processing, or some other specialized tasks.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

EXAMPLE EMBODIMENT 1. A system comprising: a peripheral component interconnect express (PCIe) add-in card that comprises a programmable fabric comprising: a plurality of PCIe physical functions; and switch circuitry having one or more embedded endpoints that dynamically hides or exposes one or more of the plurality of PCIe physical functions from a bare metal mode host server without using a reset.

EXAMPLE EMBODIMENT 2. The system of example embodiment 1, wherein the programmable fabric comprises a field-programmable gate array.

EXAMPLE EMBODIMENT 3. The system of example embodiment 1, wherein the programmable fabric comprises an application-specific integrated circuit.

EXAMPLE EMBODIMENT 4. The system of example embodiment 1, comprising the bare metal mode host server coupled to the PCIe add-in card via a PCIe port connection.

EXAMPLE EMBODIMENT 5. The system of example embodiment 4, wherein hiding or exposing the one or more of the plurality of PCIe physical functions is initiated via the bare metal mode host server.

EXAMPLE EMBODIMENT 6. The system of example embodiment 1, wherein the PCIe add-in card comprises an orchestration controller system on a chip (SoC).

EXAMPLE EMBODIMENT 7. The system of example embodiment 6, wherein the SoC performs backdoor register reprogramming to dynamically expose or hide the one or more of the plurality of PCIe physical functions.

EXAMPLE EMBODIMENT 8. The system of example embodiment 7, wherein the switch circuitry comprises a PCIe upstream switch port, and the backdoor register programming comprises the SoC reprogramming an upstream register corresponding to the PCIe upstream switch port.

EXAMPLE EMBODIMENT 9. The system of example embodiment 8, comprising a plurality of PCIe downstream switch ports, wherein respective PCIe downstream switch ports of the plurality of PCIe downstream switch ports correspond to respective PCIe physical functions of the plurality of PCIe physical functions, and the backdoor register programming comprises the SoC reprogramming one or more PCIe downstream switch ports of the plurality of PCIe downstream switch ports corresponding to the one or more of the plurality of PCIe physical functions.

EXAMPLE EMBODIMENT 10. The system of example embodiment 9, wherein respective PCIe downstream switch ports of the plurality of PCIe downstream switch ports correspond to respective hot plug controllers of a plurality of hot plug controllers.

EXAMPLE EMBODIMENT 11. The system of example embodiment 7, wherein the backdoor register programming comprises accessing or changing values in endpoint registers corresponding to the one or more of the plurality of PCIe physical functions.

EXAMPLE EMBODIMENT 12. The system of example embodiment 11, wherein changing the values in the endpoint registers comprises setting a device type for at least one of the one or more of the plurality of PCIe physical functions in a respective endpoint register of the endpoint registers.

EXAMPLE EMBODIMENT 13. The system of example embodiment 1, wherein the PCIe add-in card hides or exposes the one or more of the plurality of PCIe physical functions according to fields specified in a vendor-defined message.

EXAMPLE EMBODIMENT 14. A method comprising: receiving, at a peripheral component interconnect express (PCIe) add-in card, a request to expose a PCIe device in a programmable logic device of the PCIe add-in card to a bare metal mode host server coupled to the PCIe add-in card; determining a target register in the PCIe add-in card based on the request; and changing the register in the PCIe add-in card to expose the PCIe device to the bare metal mode host server.

EXAMPLE EMBODIMENT 15. The method of example embodiment 14, wherein changing the register comprises performing backdoor programming of the register using an orchestration controller system on a chip.

EXAMPLE EMBODIMENT 16. The method of example embodiment 14, wherein changing the register comprises changing the register based on a vendor-defined message sent to the PCIe add-in card.

EXAMPLE EMBODIMENT 17. The method of example embodiment 14, wherein receiving the request comprises a request to expose all PCIe devices of the PCIe add-in card based on a common device type between the PCIe devices, and changing a register comprises changing multiple registers to expose all of the PCIe devices of the PCIe add-in card having the common device type.

EXAMPLE EMBODIMENT 18. A method comprising: exposing a peripheral component interconnect express (PCIe) device of a plurality of PCIe devices of a programmable fabric of a PCIe add-in card to a bare metal mode host server coupled to the PCIe add-in card; receiving, at the PCIe add-in card, a request to hide the PCIe device from the bare metal mode host server coupled to the PCIe add-in card; and changing a register in the PCIe add-in card to hide the PCIe device from the bare metal mode host server.

EXAMPLE EMBODIMENT 19. The method of example embodiment 18, wherein exposing the PCIe device comprises exposing the PCIe device as a default exposure as part of a startup of the bare metal mode host server.

EXAMPLE EMBODIMENT 20. The method of example embodiment 18, wherein changing the register comprises changing the register using a system on chip (SoC) of the PCIe add-in card or based on a vendor-defined message to bypass the So

What is claimed is:

1. A system comprising:
a peripheral component interconnect express (PCIe) device that comprises a programmable fabric comprising:
a plurality of PCIe physical functions; and
switch circuitry having one or more embedded endpoints that dynamically hides or exposes one or more of the plurality of PCIe physical functions from a bare metal mode host server without using a reset.

2. The system of claim 1, wherein the programmable fabric comprises a field-programmable gate array.

3. The system of claim 1, wherein the programmable fabric comprises an application-specific integrated circuit.

4. The system of claim 1, comprising the bare metal mode host server coupled to the PCIe device via a PCIe port connection.

5. The system of claim 4, wherein the PCIe device comprises a PCIe add-in card.

6. The system of claim 1, wherein the PCIe add-in card comprises an orchestration controller system on a chip (SoC).

7. The system of claim 6, wherein the SoC performs backdoor register reprogramming to dynamically expose or hide the one or more of the plurality of PCIe physical functions.

8. The system of claim 7, wherein the switch circuitry comprises a PCIe upstream switch port, and the backdoor register programming comprises the SoC reprogramming an upstream register corresponding to the PCIe upstream switch port.

9. The system of claim 8, comprising a plurality of PCIe downstream switch ports, wherein respective PCIe downstream switch ports of the plurality of PCIe downstream switch ports correspond to respective PCIe physical functions of the plurality of PCIe physical functions, and the backdoor register programming comprises the SoC reprogramming downstream registers of the one or more PCIe downstream switch ports of the plurality of PCIe downstream switch ports corresponding to the one or more of the plurality of PCIe physical functions.

10. The system of claim 9, wherein respective PCIe downstream switch ports of the plurality of PCIe downstream switch ports correspond to respective hot plug controllers of a plurality of hot plug controllers.

11. The system of claim 7, wherein the backdoor register programming comprises accessing or changing values in endpoint registers corresponding to the one or more of the plurality of PCIe physical functions.

12. The system of claim 11, wherein changing the values in the endpoint registers comprises setting a device type for at least one of the one or more of the plurality of PCIe physical functions in a respective endpoint register of the endpoint registers.

13. The system of claim 1, wherein the PCIe add-in card hides or exposes the one or more of the plurality of PCIe physical functions according to fields specified in a vendor-defined message.

14. A method comprising:
receiving, at a peripheral component interconnect express (PCIe) device, a request to expose a PCIe endpoint in a programmable logic device of the PCIe device to a bare metal mode host server coupled to the PCIe device;
determining a target register in the PCIe device based on the request; and
changing the register in the PCIe device to expose the PCIe endpoint to the bare metal mode host server.

15. The method of claim 14, wherein changing the register comprises performing backdoor programming of the register using an orchestration controller system on a chip.

16. The method of claim 14, wherein changing the register comprises changing the register based on a vendor-defined message sent to the PCIe device.

17. The method of claim 14, wherein receiving the request comprises a request to expose all PCIe endpoints of the PCIe device based on a common device type between the PCIe endpoints, and changing a register comprises changing multiple registers to expose all of the PCIe endpoints of the PCIe device having the common device type.

18. A method comprising:
exposing a peripheral component interconnect express (PCIe) endpoint of a plurality of PCIe endpoints of a programmable fabric of a PCIe device to a bare metal mode host server coupled to the PCIe device;
receiving, at the PCIe device, a request to hide the PCIe endpoint from the bare metal mode host server coupled to the PCIe device; and
changing a register in the PCIe device to hide the PCIe endpoint from the bare metal mode host server.

19. The method of claim 18, wherein exposing the PCIe endpoint comprises exposing the PCIe endpoint as a default exposure as part of a startup of the bare metal mode host server.

20. The method of claim 18, wherein changing the register comprises changing the register using a system on chip (SoC) of the PCIe device or based on a vendor-defined message to bypass the SoC.
